(19) United States
(12) Patent Application Publication
(10) Pub. No.: US 2017/0138418 A1
(43) Pub. Date: May 18, 2017

(54) METHOD FOR LEARNING CLUTCH CHARACTERISTIC IN DUAL CLUTCH TRANSMISSION VEHICLE

(71) Applicant: HYUNDAI MOTOR COMPANY, SEOUL (KR)

(72) Inventors: Sung Hyun CHO, Yongin-Si (KR); Ho Young LEE, Bucheon-Si (KR)

(21) Appl. No.: 15/067,215

(22) Filed: Mar. 11, 2016

(30) Foreign Application Priority Data
Nov. 18, 2015 (KR) 10-2015-0161821

(51) Int. Cl. F16D 48/06; F16H 63/46

(52) U.S. Cl. CPC F16D 48/06; F16H 63/46; F16H 3/006

(57) ABSTRACT

A method for learning a characteristic of a clutch in a DCT vehicle includes a shifting condition determination step for determining whether a shifting condition is satisfied, a synchronization step for partly reducing torque of a disengagement-side clutch in order to synchronize an engine speed with a speed of an engagement-side input shaft when shifting is started when the shifting condition is satisfied, a clutch release determination step for determining whether a slip amount of a disengagement-side clutch exceeds a reference slip amount, and a disengagement-side clutch learning step for updating clutch torque on a characteristic curve of the disengagement-side clutch using the torque of the disengagement-side clutch that is controlled to allow the slip amount of the disengagement-side clutch to exceed the reference slip amount in the clutch release determination step, and for learning the updated clutch torque.

### CROSS REFERENCE TO RELATED APPLICATION

The present application claims the benefit of priority to Korean Patent Application No. 10-2015-0161821, filed Nov. 18, 2015 with the Korean Intellectual Property Office, the entire contents of which is incorporated herein for all purposes by this reference.

### TECHNICAL FIELD

The present disclosure generally relates to a method for learning the characteristic of a dry clutch. More particularly, the present disclosure relates to a method for learning the characteristic of a clutch in a Dual Clutch Transmission (DCT) vehicle.

### BACKGROUND

An automated manual transmission is a system for automatically controlling a transmission that is based on a manual transmission mechanism. Unlike an automatic transmission that uses a torque converter and a wet-type multidisc clutch, the automated manual transmission transmits engine torque using a dry clutch.

Particularly, a dry clutch has characteristics that the clutch transmission torque varies depending on various factors such as the error tolerances of components, abrasion due to wear, thermal deformation caused by high temperatures, variations in coefficients of friction of discs, and the like. Accordingly, it is difficult to estimate torque transmitted during the driving of a vehicle.

Also, when the variation in transmission torque is not detected while the clutch is controlled, because excessive slip of the clutch or shock may occur in the clutch, an algorithm for estimating in real time torque characteristics of a dry clutch may be necessary.

A conventional method estimates the clutch transmission torque through clutch control, which predicts a Torque-Stroke (T-S) curve of the dry clutch. Here, the T-S curve is a curve illustrating a transmission torque characteristic of the dry clutch depending on the stroke of a clutch actuator.

In the case of a Torque-Stroke (T-S) curve of the dry clutch, friction characteristics may irregularly change unlike a wet-type clutch. Depending on these characteristics of the dry clutch, as more sections of the curve are learned, stable driving performance and shift quality may be provided. Also, because the slip of the dry clutch may be minimized, an advantageous improvement in clutch durability may result.

Therefore, in order to obtain stable shift quality when starting a vehicle and shifting a gear, it may be necessary to learn the characteristic of a dry clutch more frequently.

The foregoing is intended merely to aid in the understanding of the background of the present disclosure, and is not intended to mean that the present disclosure falls within the purview of the related art that is already known to those skilled in the art.

### SUMMARY OF THE DISCLOSURE

Accordingly, the present disclosure has been made keeping in mind the above problems occurring in the related art, and the present disclosure is intended to provide a method for learning the characteristic of a clutch in a DCT vehicle, which stably changes speed during shifting and improves the shift quality by detecting the change of the characteristic of the dry clutch in an early stage of the shifting process.

In order to achieve the above object, a method for learning the characteristic of a clutch in a DCT vehicle according to the present disclosure may include: a shifting condition determination step for determining whether a shifting condition is satisfied; a synchronization step for partly reducing torque of a disengagement-side clutch in order to synchronize an engine speed with a speed of an engagement-side input shaft when shifting is started as the shifting condition is satisfied; a clutch release determination step for determining whether a slip amount of a disengagement-side clutch exceeds a reference slip amount in the synchronization step; and a disengagement-side clutch learning step for updating clutch torque on a characteristic curve of the disengagement-side clutch using the torque of the disengagement-side clutch that is controlled to allow the slip amount of the disengagement-side clutch to exceed the reference slip amount in the clutch release determination step, and for learning the updated clutch torque.

In the clutch release determination step, whether a state in which the slip amount of the disengagement-side clutch exceeds the reference slip amount is maintained during a predetermined time may be further determined; and in the disengagement-side clutch learning step, the clutch torque on the characteristic curve of the disengagement-side clutch may be updated using the torque of the disengagement-side clutch that is controlled to allow the state in which the slip amount of the disengagement-side clutch exceeds the reference slip amount to be maintained during the predetermined time, and the updated clutch torque may be learned.

In the shifting condition determination step, an APS signal is input in response to stepping on an acceleration pedal, and whether a power-on downshifting condition, in which shifting into a gear lower than a current gear is required, is satisfied may be determined.

The method may further include: a torque handover step for releasing the disengagement-side clutch and engaging an engagement-side clutch through torque handover control after the synchronization step, the torque handover control releasing the torque of the disengagement-side clutch and applying torque of the engagement-side clutch; an engagement-side clutch slip step for reducing the torque of the engagement-side clutch to cause a slip of the engagement-side clutch after the torque handover step; a clutch slip determination step for determining whether a slip amount of the engagement-side clutch exceeds a reference slip amount in a process of reducing the torque of the engagement-side clutch torque; and an engagement-side clutch learning step for updating clutch torque on a characteristic curve of the engagement-side clutch using the torque of the engagement-side clutch that is controlled to allow the slip amount of the engagement-side clutch to exceed the reference slip amount in the clutch slip determination step, and for learning the updated clutch torque.

In the clutch slip determination step, whether a state in which the slip amount of the engagement-side clutch exceeds the reference slip amount is maintained during a predetermined time may be further determined; and in the engagement-side clutch learning step, the clutch torque on the characteristic curve of the engagement-side clutch may be updated using the torque of the engagement-side clutch that is controlled to allow the state in which the slip amount of the engagement-side clutch exceeds the reference slip amount to be maintained during the predetermined time, and the updated clutch torque may be learned.

Whether the shifting condition is satisfied may be determined by a controller; the engagement-side input shaft speed and a disengagement-side input shaft speed may be measured using an input shaft speed sensor arranged in each of the input shafts, and thereby the slip amount of the corresponding clutch may be calculated; the torque of the engagement-side clutch and the torque of the disengagement-side clutch may be calculated based on a stroke of a corresponding clutch actuator; and a clutch characteristic curve may be set in the controller, and clutch torque of the clutch characteristic curve may be updated using the clutch torque learned in the disengagement-side clutch learning step, the clutch characteristic curve representing a relationship between the stroke of a corresponding clutch actuator and clutch torque.

According to the present disclosure, during power-on downshifting, after the characteristic of a dry clutch is learned through one section of a T-S curve, another section of the T-S curve is additionally learned, whereby the change of the characteristic of the dry clutch is early detected. Therefore, the speed during shifting may be stably changed and shift quality may be improved.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a view illustrating an entire structure of a DCT vehicle;

FIG. 2 is a view illustrating a control flow of a method for learning a characteristic of a clutch according to the present disclosure;

FIG. 3 is a view for describing an engine speed, a clutch speed and a behavior of torque, during shifting in order to learn a characteristic of a clutch according to the present disclosure; and

FIG. 4 is a view for describing a principle for adjusting a clutch characteristic curve through a method for learning the characteristic of a clutch according to the present disclosure.

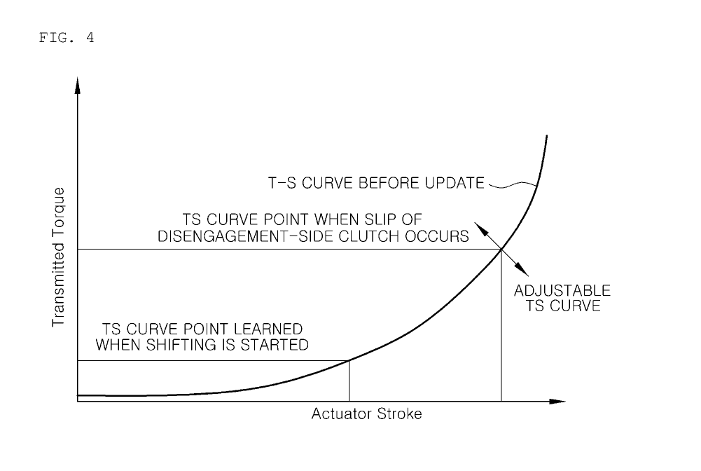

### DETAILED DESCRIPTION OF THE DISCLOSURE

Hereinbelow, exemplary embodiments of the present disclosure will be described in detail with reference to the accompanying drawings.

A method for learning a characteristic of a clutch in a DCT vehicle according to the present disclosure may include a shifting condition determination step, a synchronization step, a clutch release determination step, and a disengagement-side clutch learning step.

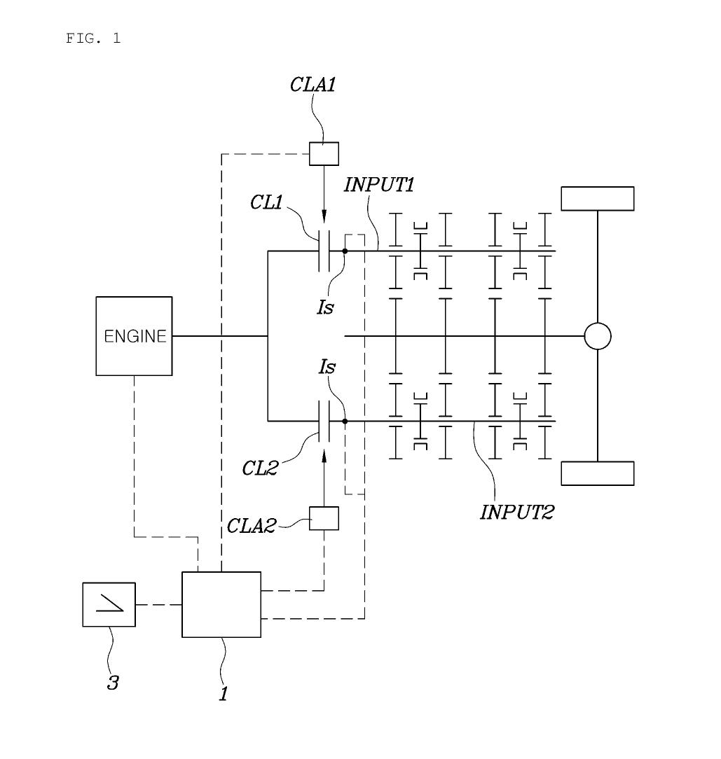

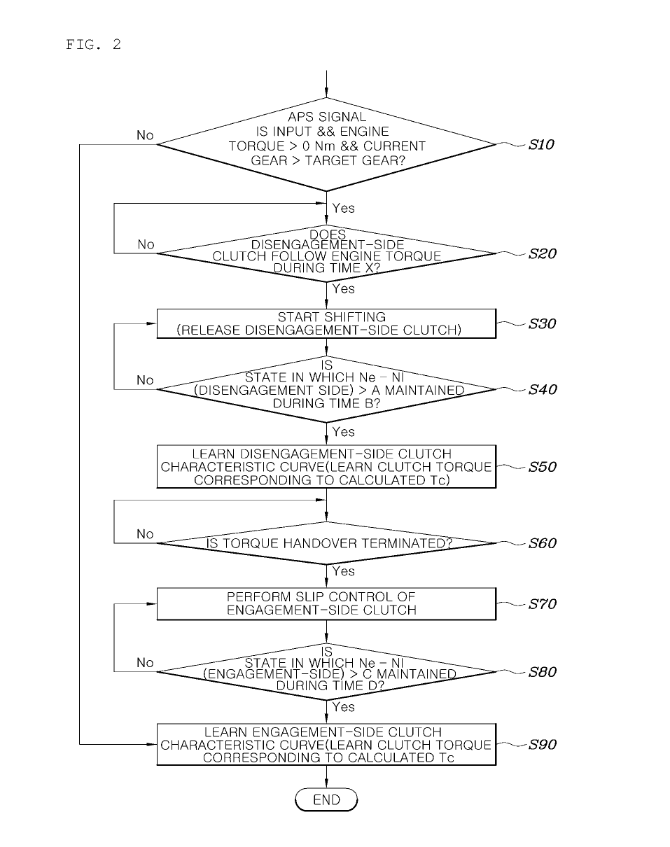

Specifically describing the present disclosure with reference to FIGS. 1 and 2, a controller 1 may receive values that represent the driving state of a vehicle and determine whether the current driving state satisfies a shifting condition in the shifting condition determination step.

For example, in the shifting condition determination step, an APS signal is input in response to stepping on an acceleration pedal 3, and whether a power-on downshifting condition is satisfied may be determined. Here, the power-on downshifting condition may refer to a state in which shifting into a target gear that is lower than the current gear is required.

If the corresponding condition is satisfied, it may be determined whether disengagement-side clutch torque follows engine torque during a predetermined time.

In the synchronization step, when shifting is started because the shifting condition may be satisfied in the shifting condition determination step, a controller 1 may control a disengagement-side clutch to be partially released by partly reducing torque thereof in order to synchronize the engine speed with the speed of an engagement-side input shaft.

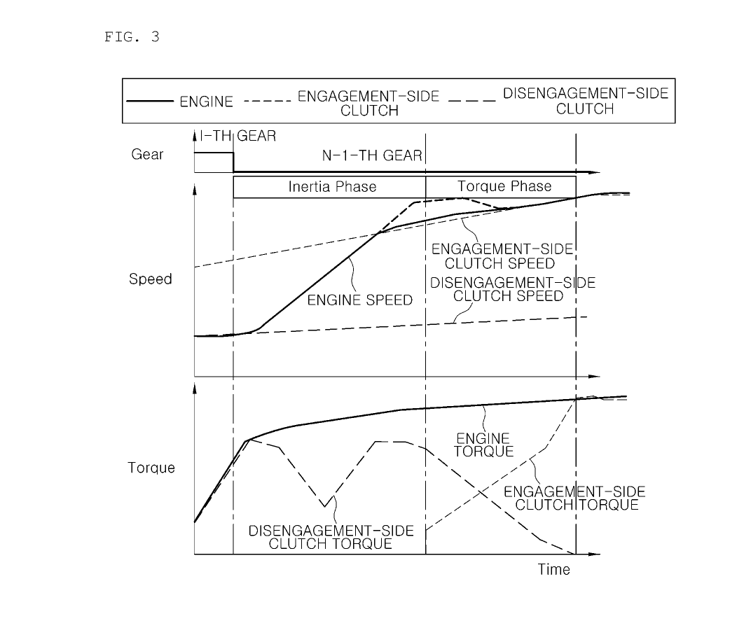

For example, at an early stage of the inertia phase section shown in FIG. 3, in which actual shifting is started, engine torque is increased by partly reducing the torque of the disengagement-side clutch through a manipulation of a disengagement-side clutch actuator CLA2. Accordingly, slip of the disengagement-side clutch CL2 occurs, and the engine speed increases to follow the engagement-side clutch speed so as to be synchronized therewith.

In this case, after partly reducing the torque of the disengagement-side clutch, the torque is applied again before the engine speed is synchronized with the engagement-side clutch speed, whereby the engine speed may be prevented from flaring, and torque handover, which will be described later, may be prepared.

In the present disclosure, the engagement-side clutch and the disengagement-side clutch are respectively expressed as reference numerals CL1 and CL2, and the engagement-side clutch actuator and the disengagement-side clutch actuator are respectively expressed as reference numerals CLA1 and CLA2. However, this is an example for convenience of understanding the present disclosure, and the engagement-side clutch and the disengagement-side clutch may be selected depending on which clutch is the clutch for a current gear or the clutch for a target gear.

Next, in the clutch release determination step, it may be determined whether the slip amount of the disengagement-side clutch CL2 exceeds a reference slip amount.

Desirably, it is further determined whether the state in which the slip amount of the disengagement-side clutch CL2 exceeds the reference slip amount is maintained during a predetermined time. Accordingly, it may be determined whether the slip of the disengagement-side clutch CL2 occurs due to the decrease in the torque of the disengagement-side clutch or it temporarily occurs due to external disturbance, regardless of the decrease in the torque of the disengagement-side clutch.

For example, it is determined whether the difference between the engine revolutions and revolutions of the disengagement-side input shaft exceeds a predetermined revolution level, and whether such a state is maintained during a predetermined time.

To this end, an input shaft speed sensor may be arranged in the disengagement-side input shaft, and the slip amount of the disengagement-side clutch CL2 may be calculated using it

Also, in the disengagement-side clutch learning step, the disengagement-side clutch torque that is controlled to allow the slip amount of the disengagement-side clutch CL2 to exceed the reference slip amount in the clutch release determination step may be used to update the clutch torque on the characteristic curve of the disengagement-side clutch, and the updated clutch torque may be learned.

Desirably, the disengagement-side clutch torque that is controlled to allow the state in which the slip amount of the disengagement-side clutch CL2 exceeds the reference slip amount to be maintained during the predetermined time may be used to update the clutch torque on the clutch characteristic curve of the disengagement-side clutch, and the updated clutch torque may be learned.

In other words, in order to change the engine speed to the synchronous speed by controlling the disengagement-side clutch within the inertia phase section of the early stage of power-on downshifting, the clutch torque may be acquired through the following equation,

Tc−Te−dNe/dt·ω

where Tc denotes clutch torque, Te denotes engine torque, dNe/dt denotes engine angular acceleration, and ω denotes engine rotational inertia.

Here, the engine angular acceleration is generated through the above equation on the assumption that the torque of the disengagement-side clutch, which corresponds to Tc, is matched with the T-S curve characteristic set in the controller 1. However, if Tc is inaccurate, dNe/dt may not generate a desired profile. As a result, the change in speed during shifting is uneven, and a driver may feel that acceleration is delayed or may feel a shifting shock.

In other words, in the controller 1, a clutch characteristic curve (T-S curve), which represents the relationship between the stroke of a clutch actuator and clutch torque, is set. Here, the current torque of the disengagement-side uses the data of the clutch characteristic curve (T-S curve), which is previously set, rather than data acquired from an engine torque section learned by the disengagement-side clutch, thus the engine speed may flare.

Therefore, in the present disclosure, a point on the T-S curve that corresponds to the time at which the slip of the disengagement-side clutch occurs is acquired in an early stage of an actual shifting process, and then the previously learned T-S curve characteristic is adjusted by being updated accordingly. As a result, the change of the characteristic of the dry clutch is detected in the early stage, and the speed during shifting is stably changed and shift quality is improved.

Meanwhile, the present disclosure may further include a torque handover step, an engagement-side clutch slip step, a clutch slip determination step, and an engagement-side clutch learning step.

Referring to FIGS. 2 and 3, in the torque handover step, after the synchronization step, the disengagement-side clutch CL2 may be disengaged and the engagement-side clutch CL1 may be engaged through torque handover, in which the torque of the disengagement-side clutch is released through the disengagement-side clutch actuator CLA2 while the torque of the engagement-side clutch is applied through the engagement-side clutch actuator CLA1.

In the engagement-side clutch slip step after the torque handover step, the engagement-side clutch may be released to cause the slip of the engagement-side clutch CL1.

Also, in the clutch slip determination step, the controller 1 may determine whether the slip amount of the engagement-side clutch CL1 exceeds a reference slip amount in the process of releasing the engagement-side clutch.

Desirably, it may be further determined whether the state in which the slip amount of the engagement-side clutch CL1 exceeds the reference slip amount is maintained during a predetermined time, whereby it may be determined whether the slip of the engagement-side clutch CL1 occurs due to the release of the engagement-side clutch, or if it temporarily occurs due to external disturbance regardless of the release of the engagement-side clutch.

For example, it may be determined whether the difference between the engine revolutions and revolutions of the engagement-side input shaft exceeds a predetermined revolution level, and whether such a state is maintained during a predetermined time.

To this end, an input shaft speed sensor may be arranged in the engagement-side input shaft, and the slip amount of the engagement-side clutch CL1 may be calculated using the input shaft speed sensor.

Next, in the engagement-side clutch learning step, the engagement-side clutch torque that is controlled to allow the slip amount of the engagement-side clutch CL1 to exceed the reference slip amount may be used to update the clutch torque on the clutch characteristic curve of the engagement-side clutch, and the updated clutch torque may be learned.

Desirably, the engagement-side clutch torque that is controlled to allow the state in which the slip amount of the engagement-side clutch CL1 exceeds the reference slip amount to be maintained during the predetermined time may be used to update the clutch torque on the clutch characteristic curve of the engagement-side clutch, and the updated clutch torque may be learned accordingly.

In the case of the engagement-side clutch CL1, because the engagement-side clutch torque is controlled using the clutch characteristic curve based on the previous shifting process, it is difficult to respond to the change of the characteristic of the clutch, thus engine speed may flare.

Therefore, in the present disclosure, a point on the T-S curve that corresponds to the time at which the slip of the engagement-side clutch occurs after torque handover is acquired, and then the previously learned T-S curve characteristic is updated accordingly. As a result, the change of the characteristic of the dry clutch is detected in the early stage, speed during shifting is stably changed, and shift quality is improved.

A control flow of the method for learning the characteristic of a clutch in a DCT vehicle according to the present disclosure is described with reference to FIGS. 2 and 3.

Using values that represent the driving state of a vehicle, for example, when an APS signal is input in response to stepping on the acceleration pedal 3, the engine torque exceeds 0 Nm, and shifting into a gear that is lower than a current gear, it may be determined that a power-on downshifting condition is satisfied.

Subsequently, when the corresponding condition is satisfied, a disengagement-side clutch CL2 may be controlled to follow the engine torque during a predetermined time X at step S20.

Then, at step S30, the torque of the disengagement-side clutch may be partly reduced so as to increase engine torque, and thereby the engine speed is synchronized with the engagement-side clutch speed.

In the synchronization process, whether the slip amount of the disengagement-side clutch CL2 exceeds value A may be determined and whether such a state is maintained during time B is determined at step S40.

As the result of the determination at step S40, when it is determined that the slip amount of the disengagement-side clutch CL2 exceeds value A and the state is maintained during time B, the characteristic curve of the disengagement-side clutch may be updated using the torque of the disengagement-side clutch and learned at step S50.

Subsequently, after torque handover of the engagement-side clutch CL1 and the disengagement-side clutch CL2 is performed through torque handover control, whether torque handover control is terminated is determined at step S60. When it is determined that torque handover control is terminated, the slip of the engagement-side clutch CL1 may be caused at step S70.

Subsequently, whether the slip amount of the engagement-side clutch CL1 exceeds value C through the slip of the engagement-side clutch CL1 may be determined, and whether the state is maintained during time D may be determined at step S80.

As the result of the determination at step S80, when the slip amount of the engagement-side clutch CL1 exceeds value C and the state is maintained during time D, the torque of the engagement-side clutch at this time may be used to update the previously learned characteristic curve of the engagement-side clutch, and the updated torque may be learned at step S90.

As described above, during power-on downshifting, after the characteristic of a dry clutch is learned according to one section of a T-S curve, another section of the T-S curve is additionally learned, whereby the change of the characteristic of the dry clutch is detected early. Therefore, the speed during shifting may be stably changed and shift quality may be improved.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A method for learning a characteristic of a clutch in a DCT vehicle, comprising:
a shifting condition determination step for determining whether a shifting condition is satisfied;
a synchronization step for partly reducing torque of a disengagement-side clutch in order to synchronize an engine speed with a speed of an engagement-side input shaft when shifting is started when the shifting condition is satisfied;
a clutch release determination step for determining whether a slip amount of a disengagement-side clutch exceeds a reference slip amount in the synchronization step; and
a disengagement-side clutch learning step for updating clutch torque on a characteristic curve of the disengagement-side clutch using the torque of the disengagement-side clutch that is controlled to allow the slip amount of the disengagement-side clutch to exceed the reference slip amount in the clutch release determination step, and for learning the updated clutch torque.

2. The method of claim 1, wherein:
in the clutch release determination step, whether a state in which the slip amount of the disengagement-side clutch exceeds the reference slip amount is maintained during a predetermined time is further determined; and
in the disengagement-side clutch learning step, the clutch torque on the characteristic curve of the disengagement-side clutch is updated using the torque of the disengagement-side clutch that is controlled to allow the state in which the slip amount of the disengagement-side clutch exceeds the reference slip amount to be maintained during the predetermined time, and the updated clutch torque is learned.

3. The method of claim 1, wherein in the shifting condition determination step, an APS signal is input in response to stepping on an acceleration pedal, and whether a power-on downshifting condition, in which shifting into a gear lower than a current gear is required, is satisfied is determined.

4. The method of claim 1, further comprising:
a torque handover step for releasing the disengagement-side clutch and engaging an engagement-side clutch through torque handover control after the synchronization step, the torque handover control releasing the torque of the disengagement-side clutch and applying torque of the engagement-side clutch;
an engagement-side clutch slip step for reducing the torque of the engagement-side clutch to cause a slip of the engagement-side clutch after the torque handover step;
a clutch slip determination step for determining whether a slip amount of the engagement-side clutch exceeds a reference slip amount in a process of reducing the torque of the engagement-side clutch torque; and
an engagement-side clutch learning step for updating clutch torque on a characteristic curve of the engagement-side clutch using the torque of the engagement-side clutch that is controlled to allow the slip amount of the engagement-side clutch to exceed the reference slip amount in the clutch slip determination step, and for learning the updated clutch torque.

5. The method of claim 4, wherein in the clutch slip determination step, whether a state in which the slip amount of the engagement-side clutch exceeds the reference slip amount is maintained during a predetermined time is further determined; and
in the engagement-side clutch learning step, the clutch torque on the characteristic curve of the engagement-side clutch is updated using the torque of the engagement-side clutch that is controlled to allow the state in which the slip amount of the engagement-side clutch exceeds the reference slip amount to be maintained during the predetermined time, and the updated clutch torque is learned.

6. The method of claim 1, wherein:
whether the shifting condition is satisfied is determined by a controller;
the engagement-side input shaft speed and a disengagement-side input shaft speed are measured using an input shaft speed sensor arranged in each of the input shafts, and thereby the slip amount of the corresponding clutch is calculated;
the torque of the engagement-side clutch and the torque of the disengagement-side clutch are calculated based on a stroke of a corresponding clutch actuator; and
a clutch characteristic curve is set in the controller, and clutch torque of the clutch characteristic curve is updated using the clutch torque learned in the disengagement-side clutch learning step, the clutch characteristic curve representing a relationship between the stroke of a corresponding clutch actuator and clutch torque.
